(19) United States
(12) Patent Application Publication
(10) Pub. No.: US 2015/0181383 A1
(43) Pub. Date: Jun. 25, 2015

(54) LOCATION-BASED MESSAGES

(71) Applicants: Egan Schulz, San Jose, CA (US); Michelle Serrano, San Jose, CA (US); Libo Su, San Jose, CA (US); Kamal Zamer, Austin, TX (US)

(72) Inventors: Egan Schulz, San Jose, CA (US); Michelle Serrano, San Jose, CA (US); Libo Su, San Jose, CA (US); Kamal Zamer, Austin, TX (US)

(21) Appl. No.: 14/137,952

(22) Filed: Dec. 20, 2013

(51) Int. Cl. H04W 4/02; H04W 8/18

(52) U.S. Cl. CPC H04W 4/021; H04W 8/18; H04W 4/12

(57) ABSTRACT

Methods and systems related to the communication of location-based messages are described. A first user (e.g., sender) leaves a message with a service provider for use at a location, and the message is accessed and transmitted by the service provider to user devices in the vicinity of the location. The first user can specify who receives the message or the message may be broadcast without restrictions. The message can then be presented on a user device of a second user (e.g., recipient) if the message satisfies certain criteria. The criteria may include location history, purchase history, age of the message, subject matter of the message, identity of the originator of the message, date and time, area code, type of user device, or a combination thereof.

### BACKGROUND

1. Field of the Invention

The present invention generally relates to location-based messages, and more specifically to communicating location-based messages from one user to another user.

2. Related Art

The incorporation of tracking technology in today's handheld mobile devices has led to a vast emergence of location based services. Location based services present an advantageous addition to conventional messaging services. For instance, location based services enable consumers to send a message based on the location of a potential recipient's mobile device. Hence, tracking technology enables a subscriber to transmit a message to a user having a mobile device at a particular location, or to a user having a mobile device within a predetermined proximity to a particular location.

Location based services are particularly useful for business, contributing to both internal and external business endeavors. For instance, location based messaging facilitates a business to target promotional information to relevant consumers, and/or corporate information to employees, based on potential recipients' proximity to a particular site of interest. Moreover, location based services enable a business to engage in location based advertising via transmission of promotional/marketing messages.

When a consumer is at a certain location, he or she may want to access reviews, comments, or recommendations, or post a question regarding a certain product or service at the location. Typically, to find reviews, the consumer has to perform a search by typing in terms to find reviews posted by other users. To post a question, the consumer may have to personally ask other users online or face-to-face. This is cumbersome and inconvenient for the consumer. Thus, a need exists for systems and methods that are more user-friendly and require less effort on the part of the consumer.

### BRIEF DESCRIPTION OF THE FIGURES

FIG. 1 is a block diagram illustrating a system for communicating location-based messages according to an embodiment of the present disclosure;

FIG. 2 is a flowchart showing a method for communicating location-based messages according to an embodiment of the present disclosure; and

FIG. 3 is a block diagram of a system for implementing a device according to an embodiment of the present disclosure.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

The methods and systems described herein allow a person to store location-based information. This location-based information can later be transmitted to one or several other people located at the location or in the vicinity of the location. The recipient of the information need not perform a search or submit a search request to access the location-based information. Instead, the information is posted at certain locations like Post-It digital notes for whoever may be interested in accessing and viewing the information.

The present disclosure describes the transmission of location-based messages from a first user (e.g., a sender) to a second user (e.g., a recipient). The first user leaves a message with a service provider for a location, and the message is transmitted by the service provider to user devices in the vicinity of the location. The first user can specify who receives the message or the message may be broadcast without restrictions. The message can then be presented (e.g., displayed or played) on a user device of the second user if the message satisfies certain criteria. The criteria may include location history, purchase history, age of the message, subject matter of the message (e.g., topics the recipient is interested in receiving), identity of the originator of the message, area code, type of user device, date and time, or a combination thereof.

As used herein, “message” refers to any type of communication including a text, voice, or video communication. In various embodiments, the message includes advice, reviews, ratings, comments, questions, recommendations, or a combination thereof.

In one embodiment, the first and second users know each other, and may be friends, family, co-workers, or acquaintances. In other embodiments, the first and second users have never met or are strangers who are connected only through location. That is, both the first and second users have visited the same place or location, or may reside or have significant ties to the same neighborhood. As used herein, “neighborhood” refers to a geographically localized community within a larger city, town, suburb, or rural area. Thus, the term “same neighborhood” can refer to the same street, subdivision, area, block, district, zone, territory, or region.

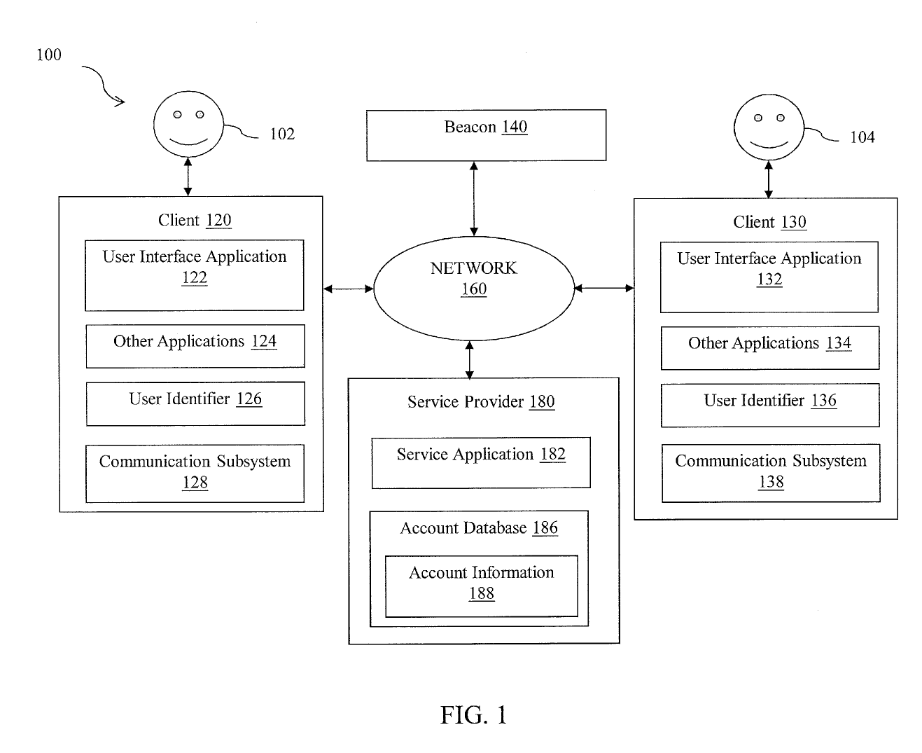

FIG. 1 shows one embodiment of a block diagram of a network-based system 100 adapted to transmit location-based messages over a network 160. As shown, system 100 may comprise or implement a plurality of servers and/or software components that operate to perform various methodologies in accordance with the described embodiments. Exemplary servers may include, for example, stand-alone and enterprise-class servers operating a server OS such as a MICROSOFT® OS, a UNIX® OS, a LINUX® OS, or other suitable server-based OS. It can be appreciated that the servers illustrated in FIG. 1 may be deployed in other ways and that the operations performed and/or the services provided by such servers may be combined or separated for a given implementation and may be performed by a greater number or fewer number of servers. One or more servers may be operated and/or maintained by the same or different entities.

As shown in FIG. 1, the system 100 includes a first client device 120 (e.g., a network computing device), a second client device 130 (e.g., a mobile device), a beacon 140 (e.g., a radio frequency beacon or Bluetooth Low Energy (BLE) beacon), and at least one service provider server or device 180 (e.g., network server device) in communication over the network 160. The network 160, in one embodiment, may be implemented as a single network or a combination of multiple networks. For example, in various embodiments, the network 160 may include the Internet and/or one or more intranets, landline networks, wireless networks, and/or other appropriate types of communication networks. In another example, the network 160 may comprise a wireless telecommunications network (e.g., cellular phone network) adapted to communicate with other communication networks, such as the Internet. As such, in various embodiments, the first client device 120, second client device 130, beacon 140 and service provider server or device 180 may be associated with a particular link (e.g., a link, such as a URL (Uniform Resource Locator) to an IP (Internet Protocol) address).

The first client device 120 and the second client device 130, in various embodiments, may be implemented using any appropriate combination of hardware and/or software configured for wired and/or wireless communication over the network 160. In various examples, first client device 120 and second client device 130 may be implemented as a wireless telephone (e.g., cellular or mobile phone), a tablet, a personal digital assistant (PDA), a personal computer, a notebook computer, and/or various other generally known types of wired and/or wireless computing devices. It should be appreciated that first client device 120 and second client device 130 may be referred to as a user device or a customer device without departing from the scope of the present disclosure. The first client device 120, in one embodiment, includes a user interface application 122, which may be utilized by the sender 102 to transmit messages to the service provider server 180 over the network 160.

In one implementation, the user interface application 122 comprises a software program, such as a graphical user interface (GUI), executable by a processor that is configured to interface and communicate with the service provider server 180 via the network 160. In another implementation, the user interface application 122 comprises a browser module that provides a network interface to browse information available over the network 160. For example, the user interface application 122 may be implemented, in part, as a web browser to view information available over the network 160.

The first client device 120, in various embodiments, may include other applications 124 as may be desired in one or more embodiments of the present disclosure to provide additional features available to sender 102. In one example, such other applications 124 may include security applications for implementing client-side security features, programmatic client applications for interfacing with appropriate application programming interfaces (APIs) over the network 160, and/or various other types of generally known programs and/or software applications. In still other examples, the other applications 124 may interface with the user interface application 122 for improved efficiency and convenience.

The first client device 120, in one embodiment, may include at least one user identifier 126, which may be implemented, for example, as operating system registry entries, cookies associated with the user interface application 122, identifiers associated with hardware of the first client device 120, or various other appropriate identifiers. The user identifier 126 may include one or more attributes related to the sender 102, such as personal information related to the sender 102 (e.g., one or more user names, passwords, photograph images, biometric IDs, addresses, phone numbers, etc.) and banking information and/or funding sources (e.g., one or more banking institutions, credit card issuers, user account numbers, security data and information, etc.). In various implementations, the user identifier 126 may be passed with a user login request to the service provider server 180 via the network 160, and the user identifier 126 may be used by the service provider server 180 to associate the sender 102 with a particular user account maintained by the service provider server 180.

In some embodiments, first client device 120 includes a communication subsystem 128, which can include radio frequency receivers and transmitters and/or optical (e.g., infrared) receivers and transmitters. The specific design and implementation of the communication subsystem 128 can depend on the communication network over which the first client device 120 is intended to operate. For example, the first client device 120 can include communication subsystems designed to operate over a Global System for Mobile Communication (GSM) network, a General Packet Radio Service (GPRS) network, an Enhanced Data Rates for Global Evolution (EDGE) network, a Wi-Fi or WiMax network, and a Bluetooth™ network.

The first client device 120, in one embodiment, includes a geo-location component adapted to monitor and provide an instant geographical location (i.e., geo-location) of the first client device 120. In one implementation, the geo-location of the first client device 120 may include global positioning system (GPS) coordinates, zip-code information, area-code information, street address information, and/or various other generally known types of geo-location information. In one example, the geo-location information may be directly entered into the first client device 120 by the sender 102 via a user input component, such as a keyboard, touch display, and/or voice recognition microphone. In another example, the geo-location information may be automatically obtained and/or provided by the first client device 120 via an internal or external GPS monitoring component. In one aspect, when interfacing with the first client device 120, the sender 102 may elect to provide or may be prompted to provide permission for the release of geo-location information. Accordingly, the sender 102 may have exclusive authority to allow transmission of geo-location information from the first client device 120 to the service provider server 180. In any instance, the service provider server 180 may communicate with the first client device 120 via the network 160 and request permission to acquire geo-location information from the first client device 120 for geo-location based mobile commerce.

Second client device 130 may have similar applications and modules as first client device 120, but is used, in this example, by recipient 104 to receive messages and other communications sent by sender 102 via the first client device 120 via the service provider server 180. Second client device 130 may also include a user interface application 132 and one or more other applications 134, which may be used, for example, to provide a convenient interface to permit recipient 104 to browse information and view messages over network 160. For example, in one embodiment, user interface application 132 may be implemented as a web browser configured to view information available over the Internet and communicate with service provider server 180 to receive and send information to sender 102.

Second client device 130 may further include other applications 134 such as security applications for implementing client-side security features, programmatic client applications for interfacing with appropriate application programming interfaces (APIs) over network 160, or other types of applications. Applications 134 may also include email, text, IM, and voice applications that allow recipient 104 to communicate through network 160 and receive messages from sender 102. Second client device 130 includes one or more user identifiers 136, which may be implemented, for example, as operating system registry entries, cookies associated with user interface application 132, identifiers associated with hardware of second client device 130, or other appropriate identifiers, such as used for payment/recipient/device authentication, e.g., the phone number associated with second client device 130. Identifiers may be used by a service provider to associate recipient 104 with a particular account maintained by the service provider. Second client device 130 may also include a communication subsystem 138 for receiving and transmitting messages and a geolocation component for tracking the location of the second client device 130, as described above with respect to first client device 120.

The client devices 120 and 130 can communicate with the service provider server 180 to receive information and messages, and transmit and receive data. In a similar fashion, service provider server 180 can communicate data and other information to client devices 120 and 130.

Beacon 140 may be set up by merchants or individuals offering various items, such as products and/or services for sale. As defined herein, a “beacon” is a short range communication device having a known or fixed location that provides a signal that can be detected by mobile devices within a certain proximity of the beacon. An example of a beacon is a radio frequency (RF) beacon (e.g., Bluetooth™ low energy (BLE) beacon), infrared beacon or a radio frequency identifier (RFID) tag. For example, a BLE beacon can broadcast an RF signal that includes its position coordinates (e.g., latitude, longitude), which can be detected by a mobile device. In some implementations, the beacon can also advertise location based services provided by a beacon network. A beacon network encompasses a plurality of beacons in a geographic region.

Beacon 140 is typically maintained by one or more service providers. When the sender 102 or the recipient 104 comes in range of beacon 140, a mobile application on the client devices 120 and/or 130 run by a service provider can wake up and connect to the beacon 140. The client devices 120, 130 can then receive messages from beacon 140. In some implementations, beacon 140 is a BLE beacon.

Beacon 140 can output a wireless signal that can be detected by client devices 120, 130 when the client devices 120, 130 are within a certain proximity of the beacon 140. Beacon 140 may be a device that periodically or continuously transmits a signal, such as a short-distance wireless (e.g., BLE), medium distance wireless (e.g., Wi-Fi), and/or other electro, magnetic, and/or electro-magnetic transmissions. Power on beacon 140 can be adjusted to communicate only within a desired range, which may depend on intended message ranges. The client devices 120, 130 are configured to detect the transmitted signals from beacon 140, such that when the client devices 120, 130 are located within the transmission range, the signal may be detected.

The service provider server 180, in one embodiment, may be maintained by a transaction processing entity, which may provide processing for financial transactions and/or information transactions between the sender 102, recipient 104, and/or beacon 140. As such, the service provider server 180 includes a service application 182, which may be adapted to interact with the client devices 120, 130 and/or the beacon 140 over the network 160. In one example, the service provider server 180 may be provided by PayPal®, Inc., eBay® of San Jose, Calif., USA, and/or one or more financial institutions or a respective intermediary that may provide multiple point of sale devices at various locations to facilitate transaction routings between merchants and, for example, financial institutions.

The service provider server 180, in one embodiment, may be configured to maintain one or more user accounts and merchant accounts in an account database 186 each of which may include account information 188 associated with one or more individual users (e.g., sender 102 and recipient 104) and merchants. For example, account information 188 may include private financial information of sender 102 and/or recipient 104, such as one or more account numbers, passwords, credit card information, banking information, or other types of financial information, which may be used to facilitate financial transactions between sender 102 and/or recipient 104 and a merchant. In various aspects, the methods and systems described herein may be modified to accommodate users and/or merchants that may or may not be associated with at least one existing user account and/or merchant account, respectively.

In one implementation, the sender 102 and/or recipient 104 may have identity attributes stored with the service provider server 180, and sender 102 and/or recipient 104 may have credentials to authenticate or verify identity with the service provider server 180. User attributes may include personal information (e.g., address, phone number, etc.), banking information and/or funding sources. In various aspects, the user attributes may be passed to the service provider server 180 as part of a login, search, selection, purchase, and/or payment request, and the user attributes may be utilized by the service provider server 180 to associate sender 102 and/or recipient 104 with one or more particular user accounts maintained by the service provider server 180.

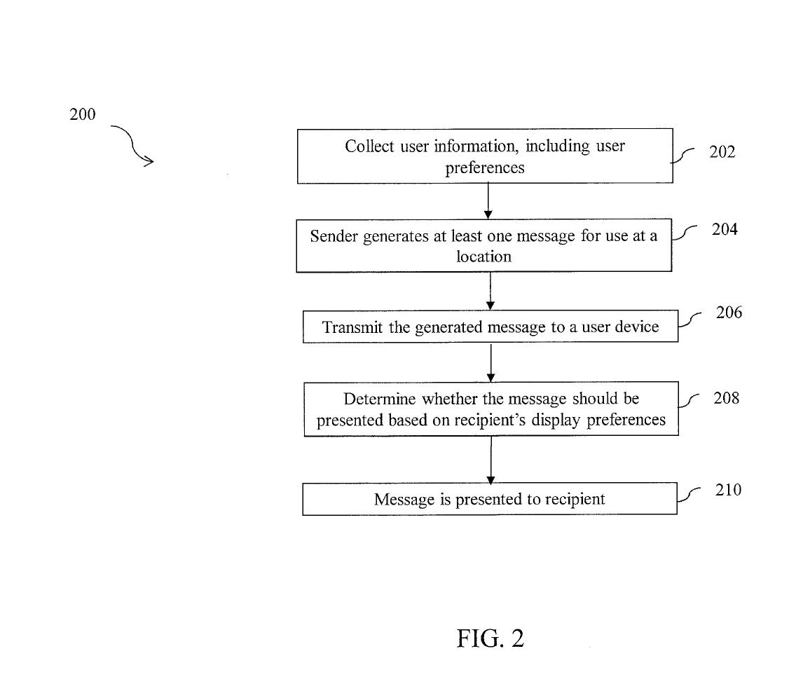

Referring now to FIG. 2, a flowchart 200 of a method for transmitting location-based messages is illustrated according to an embodiment of the present disclosure. In the embodiment of the method 200 described below, a service provider provides sender 102 and recipient 104 with a user account, and the sender 102 and the recipient 104 may transmit and receive messages via the service provider server 180. The service provider may be, for example, PayPal®, Inc. of San Jose, Calif. However, these embodiments are meant to be merely exemplary, and one of skill in the art will recognize that a variety of modifications may be made to the system discussed herein without departing from the scope of the present disclosure.

In one embodiment, sender 102 and recipient 104 both register with a service provider, which runs an application on the first and second client device 120, 130. Registration may include signing up for the service and agreeing to any terms required by the service provider. In one embodiment, the first and second client devices 120, 130 are each a smart phone, a PC, smart watch, Google Glass, a computing tablet, or other computing device. Registration may be done completely through the first and second client devices 120, 130, partially through the first and second client devices 120, 130, or without using the first or second client device 120, 130, such as through a phone call or in-person visit to a representative of the service provider.

The sender 102 and the recipient 104 may be requested to provide specific information for registration, such as, but not limited to, a name, address, phone number, email address, picture, a user name for the account, and a password or PIN for the account. The type of information may depend on whether the user already has an account with the service provider. Requested information may be entered through the user device or other means, including voice or manual key entry. Once all the requested information is received and confirmed, the service provider may create an account for the user.

The method 200 begins at step 202, where the recipient 104 provides, and the service provider server 180 collects, user information, including preferences for location-based messages. User preferences may identify the types of messages that the recipient 104 wishes to see displayed and/or hear on the second client device 130. For example, recipient 104 may want to see messages related to clothing and computers, but not messages related to food or office supplies. User preferences may encompass location history, purchase history, age of the message, subject matter of the message, identity of the originator of the message (e.g., sender 102), area code, type of user device, date and time, or a combination thereof.

Location history refers to places where a user (or his or her user device) has been. The information associated with the location history may identify one or more geographic locations where the user was located over a prior period of time. For example, the location history can provide information regarding where a user lives or resides, where a user has eaten, where a user has shopped, where a user has met friends, etc. Recipient 104 may set preferences so that he or she is only presented with messages at locations where he or she has previously been or where he or she has visited multiple times.

Purchase history refers to what a user has previously bought (e.g., particular brands or categories of products or services) and/or where he or she bought it. For example, the information associated with purchase history may show that a user likes to buy clothes from a certain retail store or enjoys dining at a specific restaurant. In one embodiment, recipient 104 may set preferences so that he or she only sees messages at locations where he or she has previously been, or locations that are associated with items/services that he or she has previously bought.

The age of the message indicates the time that has passed since a first user has posted the message and a second user has received the message. In various embodiments, recipient 104 can choose to have only recent messages (e.g., messages posted in the last week or month) displayed, while older messages (e.g., messages posted in the last 3 months or in the past year) are not displayed. In one embodiment, the owner of a beacon can choose time-outs for all messages (e.g., to keep certain things fresh, like restaurant menu items that change seasonally, etc.)

The subject matter of the message relates to the content of the message. For example, the message may contain an advertisement, promotion, coupon, review, comment, recommendation, question, etc., or the message may contain information regarding a specific topic (e.g., food, cars, clothing, electronics, toys, child care, medical care, etc.) Recipient 104 may choose to block messages that contain a promotion or advertisement, but may want to see and/or hear messages that include a review or comment. Recipient 104 may indicate that he or she is interested in food and electronics, but not toys or child care.

A user can also filter the messages that are presented based on the identity of the sender of the message. For example, the originator of the message may be a friend, co-worker, relative, contact on a social networking site, acquaintance, neighbor, stranger, etc. Recipient 104 can choose to review messages passed along by a neighbor, friend or a relative, but block messages posted by a stranger or co-worker. A receiver of a message can also post a message in answer to a previous message. If the receiver of the message responds to a message left by another user, the user can potentially be alerted about the response when the user is in a certain location, or in a separate embodiment, when the user is in the vicinity of that beacon.

In an exemplary embodiment, the service provider analyzes the location history of the sender 102 and determines whether sender 102 has sufficient ties to the location where the message is to be posted. By “sufficient” is meant that sender 102 has spent a predetermined amount of time at the location or resides at or near the location. In some instances, the service provider only allows a user with significant location history at the location to leave a message at the location or to be classified as a neighbor. For example, only a person with significant ties to the community would be able to post a message. This situation can be likened to a community board where messages related to looking for a dog sitter or offering babysitting services or yard care can be posted only by community members. If certain conditions are met (e.g., both parties agree or both parties belong to the same community), the identity of both parties may be revealed. In some embodiments, the area code of a phone number (e.g., home phone number or mobile number) of the sender 102 is determined to see whether it matches or is within a predetermined distance from the area code of a location where the message is to be posted.

The type of user device can also determine whether a message is presented. For example, one type of message may be better suited for one type of user device, such as due to display (e.g., size, resolution), speaker features, etc. In one embodiment, the service provider determines what type of user device is being used, and presents the user with messages best suited for the user device. For instance, if the user device is a mobile phone that is not equipped to display a video message, then the service provider may display a text message or play an audio message.

The date and time the message is received may also affect whether or not the user wants the message presented. For example, recipient 104 may not want to see messages after a certain time, at night, during a holiday, or a weekend. On the other hand, recipient 104 may want messages received in the morning, afternoon, or a weekday displayed on second client device 130.

At step 204, at least one message is generated by sender 102 for a specific location. In various embodiments, sender 102 can specify who receives the message. For example, sender 102 may want to post a message for a neighbor or someone who lives in the same neighborhood, or sender 102 may only want his friends or people on his contact list or social network to receive the message. In another embodiment, the message can be transmitted without restrictions. In other embodiments, sender 102 may want anyone who comes within a predetermined proximity or distance of the location to receive the message. In one embodiment, the message is used in an urban game such as a scavenger hunt where real or digital items are collected from various parts of the city. A beacon can be used to provide a clue about where to find other beacons that include another clue.

Sender 102 creates the message and sends the message to service provider server 180. The service provider server 180 associates the message with a location. The message may include a piece of advice, recommendation, review, rating, or comment that is relevant to the specific location. For example, the message may relate to services found in a store such as, “The customer service representative Jason is great! Have him help you,” or the message may relate to a specific product found in a supermarket aisle such as, “The apple plum body wash is the best! I totally love it!”

When second client device 130 is within a predetermined vicinity or distance of the location, at step 206, the service provider accesses the message and transmits the generated message to the user device. As used herein, “vicinity” refers to the areas or regions near or proximate to the location. The service provider identifies the current location of the second client device 130 and determines whether there are any messages at the current location. In embodiments where sender 102 has restricted who receives the message, the service provider may first identify recipient 104 (e.g., through a user identifier) before transmitting the message.

In an exemplary embodiment, the message is a beacon message and the message is generated by a beacon (e.g., beacon 140). The beacon may be placed inside a merchant location (e.g., supermarket, store, bar, salon, restaurant, etc.), such as at the entrance or in a specific aisle. The beacon messages are posted by consumers, and typically cannot be controlled or edited by the merchant. In this embodiment, the generated message is transmitted within a transmission range of the beacon 140 for reception by the second client device 130 located in the transmission area. The transmission range of the beacon 140 may be about 3 inches to about 75-80 feet. Thus, in narrow or short aisles, beacon power may be turned down for a shorter transmission range, while in larger areas where beacons are more widely spaced, beacon power may be turned up for a higher transmission range. Beacons in different areas of a location may be adjusted for different transmission ranges as desired.

Beacon messages can be transmitted from a beacon generation device to one or more mobile devices using a BLE wireless communication protocol. BLE is an exemplary wireless communication protocol that can be used to transmit beacon messages as described herein with low energy cost. The beacon messages are not limited to use with BLE, but can be used with other low energy or non-low energy wireless communication protocols, such as Wi-Fi.

At step 208, the recipient 104's preferences determine whether or not the message should be presented on or transmitted to second client device 130 of recipient 104. If the message meets at least one preference, the service provider server 180 presents the message to recipient 104 through the beacon 140.

In some embodiments, the service provider presents the most relevant message, e.g., the message that recipient 104 would be most interested in based on his or her preferences. Numerous messages may be associated with a location, and the service provider can review recipient 104's preferences to determine which message is most important. For example, recipient 104 previously indicated that she is most interested in recommendations for drinks at a specific restaurant. The service provider can search for and present those messages related to cocktails, wine, beer, or champagne. Messages that are related to food served at the restaurant can be suppressed. In one embodiment, recipient 104 may be asked if she wants to see the rest of the messages left at the location, and she can choose to review them or not.

At step 210, the message is displayed or otherwise presented to recipient 104. Recipient 104 can read, listen, or watch the message, and determine what he or she wants to do with the information. In certain embodiments, recipient 104 may decide to leave a message at the location for other consumers.

### Examples

Particular examples will now be described. Jim walks into a mall and heads toward a Foot Locker. His preferences are to see messages related to clothing, shoes, and computers, but not food. As he walks down an aisle of athletic shoes, a message pops up on his smartphone. The message says, “Try the Air Jordans. Ask for Timmy. He's really helpful!” Jim sees a pair of Air Jordans and tries them on. He also asks for Timmy the salesman to help him out, and Jim purchases the shoes. Jim is happy to find that Tim was in fact an incredible salesperson. As he continues shopping, he passes California Pizza Kitchen and decides to stop for a snack. Various users have left reviews, comments, and advice on what to order at the restaurant. Because Jim has chosen not to have that type of message presented, these messages do not pop up on his smartphone.

Pam wants to ask her neighbor who did their xeriscaped lawn, but has never met them and only knows where they live. Pam can open up a mobile application run by a service provider, such as eBay®, and choose to leave a message on the house for the person who lives there. When Pam's neighbor Jill comes home, Jill receives an alert on her mobile phone from Pam. Jill can respond to the message from Pam and send referrals through the service provider for the products and services she used on her home, including the xeriscaping company. Jill has elected to have messages left on her property only from neighbors, family, or friends. In this example, Pam is able to leave a message on Jill's house because Pam has significant location history in the neighborhood and has location history in a place of residence. In other words, Pam has been identified as a neighbor of Jill's. Pam and Jill are able to have a conversation, even though they have never met or communicated face-to-face.

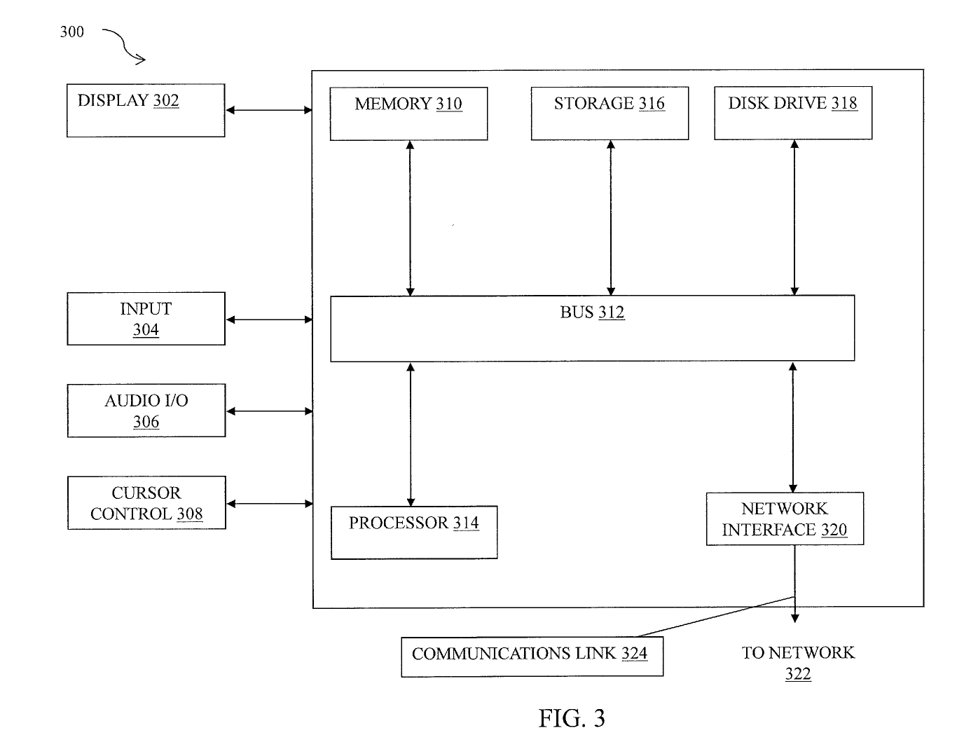

FIG. 3 is a block diagram of a computer system 300 suitable for implementing one or more embodiments of the present disclosure, including the first client device 120, the second client device 130, beacon 140, and the service provider server 180. In various implementations, the client devices 120, 130 and beacon 140 may comprise a mobile cellular phone, personal computer (PC), laptop, PDA, etc. adapted for wireless communication, and the service provider server 180 may comprise a network computing device, such as a server. Thus, it should be appreciated that the devices 120, 130, 140, and 180 may be implemented as computer system 300 in a manner as follows.

Computer system 300 includes a bus 312 or other communication mechanism for communicating information data, signals, and information between various components of computer system 300. Components include an input/output (I/O) component 304 that processes a user (i.e., sender, recipient, service provider) action, such as selecting keys from a keypad/keyboard, selecting one or more buttons or links, etc., and sends a corresponding signal to bus 312. I/O component 304 may also include an output component, such as a display 302 and a cursor control 308 (such as a keyboard, keypad, mouse, etc.). An optional audio input/output component 306 may also be included to allow a user to use voice for inputting information by converting audio signals. Audio I/O component 306 may allow the user to hear audio. A transceiver or network interface 320 transmits and receives signals between computer system 300 and other devices, such as another user device, a merchant server, or a service provider server via network 322. In one embodiment, the transmission is wireless, although other transmission mediums and methods may also be suitable. A processor 314, which can be a micro-controller, digital signal processor (DSP), or other processing component, processes these various signals, such as for display on computer system 300 or transmission to other devices via a communication link 324. Processor 314 may also control transmission of information, such as cookies or IP addresses, to other devices.

Components of computer system 300 also include a system memory component 310 (e.g., RAM), a static storage component 316 (e.g., ROM), and/or a disk drive 318. Computer system 300 performs specific operations by processor 314 and other components by executing one or more sequences of instructions contained in system memory component 310. Logic may be encoded in a computer readable medium, which may refer to any medium that participates in providing instructions to processor 314 for execution. Such a medium may take many forms, including but not limited to, non-volatile media, volatile media, and transmission media. In various implementations, non-volatile media includes optical or magnetic disks, volatile media includes dynamic memory, such as system memory component 310, and transmission media includes coaxial cables, copper wire, and fiber optics, including wires that comprise bus 312. In one embodiment, the logic is encoded in non-transitory computer readable medium. In one example, transmission media may take the form of acoustic or light waves, such as those generated during radio wave, optical, and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, or any other medium from which a computer is adapted to read.

In various embodiments of the present disclosure, execution of instruction sequences to practice the present disclosure may be performed by computer system 300. In various other embodiments of the present disclosure, a plurality of computer systems 300 coupled by communication link 324 to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The various features and steps described herein may be implemented as systems comprising one or more memories storing various information described herein and one or more processors coupled to the one or more memories and a network, wherein the one or more processors are operable to perform steps as described herein, as non-transitory machine-readable medium comprising a plurality of machine-readable instructions which, when executed by one or more processors, are adapted to cause the one or more processors to perform a method comprising steps described herein, and methods performed by one or more devices, such as a hardware processor, user device, server, and other devices described herein.

What is claimed is:

1. A system comprising:
a memory device; and
one or more processors in communication with the memory device and operable to:
determine a location of a first user device;
access a location-based message left at the location by a second user device;
determine the location-based message can be communicated to the first user device; and
electronically communicate the location-based message to the first user device when the first user device is within a predetermined distance from the location.

2. The system of claim 1, wherein the location-based message is communicated by a beacon.

3. The system of claim 2, wherein the beacon comprises a short range radio frequency beacon.

4. The system of claim 2, wherein the beacon is located in a merchant location.

5. The system of claim 1, wherein the location-based message comprises advice, a recommendation, rating, comment, question, or a combination thereof.

6. The system of claim 1, wherein the one or more processors is further operable to determine at least one preference on the first user device to determine that the location-based message can be communicated to the first user device.

7. The system of claim 6, wherein the at least one preference comprises location history, purchase history, age of the location-based message, subject matter of the location-based message, area code, type of user device, date and time, identity of an originator of the location-based message, or a combination thereof.

8. A method for communicating location-based messages, comprising:
receiving, by one or more hardware processors of a service provider, a location-based message from a first user for use at a location;
transmitting the location-based message to at least one user device associated with a second user when the at least one user device is within a predetei ined vicinity of the location; and
presenting the location-based message on the at least one user device when the location-based message satisfies at least one preference.

9. The method of claim 8, wherein the location-based message is transmitted by a beacon.

10. The method of claim 9, wherein the beacon is located in a merchant location.

11. The method of claim 8, wherein the location-based message comprises advice, a recommendation, rating, comment, question, or a combination thereof.

12. The method of claim 8, wherein the at least one preference is determined by the second user.

13. The method of claim 12, wherein the at least one preference comprises location history, purchase history, age of the location-based message, subject matter of the location-based message, area code, type of user device, date and time, identity of the first user, or a combination thereof.

14. The method of claim 8, wherein the first and second users reside in the same neighborhood.

15. A non-transitory machine-readable medium comprising a plurality of machine-readable instructions which, when executed by one or more processors, are adapted to cause the one or more processors to perform a method comprising:
determining a location of a first user device;
accessing a location-based message left at the location by a second user device;
determining the location-based message can be communicated to the first user device; and
electronically communicating the location-based message to the first user device when the first user device is within a predetermined distance from the location.

16. The non-transitory machine-readable medium of claim 15, wherein the location-based message is communicated by a beacon.

17. The non-transitory machine-readable medium of claim 16, wherein the beacon is located in a merchant location.

18. The non-transitory machine-readable medium of claim 15, wherein the location-based message comprises advice, a recommendation, rating, comment, question, or a combination thereof.

19. The non-transitory machine-readable medium of claim 15, wherein the method further comprises determining at least one preference on the first user device to determine that the location-based message can be communicated to the first user device.

20. The non-transitory machine-readable medium of claim 19, wherein the at least one preference comprises location history, purchase history, age of the location-based message, subject matter of the location-based message, area code, type of user device, date and time, identity of an originator of the location-based message, or a combination thereof.
